(19) United States
(12) Patent Application Publication
(10) Pub. No.: US 2017/0193302 A1
(43) Pub. Date: Jul. 6, 2017

(54) TASK MANAGEMENT SYSTEM AND METHOD USING AUGMENTED REALITY DEVICES

(71) Applicant: DAQRI, LLC, Los Angeles, CA (US)

(72) Inventor: Brian Mullins, Altadena, CA (US)

(21) Appl. No.: 15/399,529

(22) Filed: Jan. 5, 2017

Related U.S. Application Data
(60) Provisional application No. 62/275,009, filed on Jan. 5, 2016.

(51) Int. Cl. G06K 9/00; G02B 27/01; G06T 19/00; G09G 5/00

(52) U.S. Cl. CPC G06K 9/00671; G06K 9/00718; G09G 5/006; G02B 27/017; G06T 19/006

(57) ABSTRACT

A wearable computing device is provided. The wearable computing device includes at least one processor, a display element configured to display augmented reality (AR) content to a wearer, a location sensor providing location information, and a task management engine executed by the at least one processor. The task management engine is configured to receive a task event identifying a task to be performed, identify a location associated with the task event, display a first AR content item to the wearer, the first AR content item is a navigational aid associated with the location, detect that the wearable computing device is proximate the location, determine a task object associated with the task event, and display a second AR content item to the wearer using the display element, the second AR content item identifies the task object to the wearer in a field of view of the display element.

### CROSS-REFERENCE TO RELATED APPLICATIONS

This application claims the benefit of priority to U.S. Provisional Patent Application Ser. No. 62/275,009, filed Jan. 5, 2016, herein incorporated by reference in its entirety.

### TECHNICAL FIELD

The subject matter disclosed herein generally relates to task management. Specifically, the present disclosure addresses task management systems and methods using a wearable computing device including augmented reality content.

### BACKGROUND

An augmented reality (AR) device can be used to generate and display computer-generated content. For example, AR is a live, direct, or indirect view of a physical, real-world physical environment whose elements are augmented by computer-generated sensory input such as sound, video, graphics or GPS data. With the help of advanced AR technology (e.g., adding computer vision and object recognition) the information about the surrounding real world of the user becomes interactive. Device-generated (e.g., artificial) information about the environment and its objects can be overlaid on the real world.

Some types of tasks, such as field service work in oil refining, mining, or construction, require workers to operate tools and machinery with their hands while performing some tasks. With conventional task management systems, workers will often spend a significant portion of their time on task management and coordination tasks, such as receiving tasks from their management, determining how to do tasks, where they need to go to perform those tasks, and looking for tools or equipment needed for performing those tasks. Further, operations managers of field service workers also spend significant time managing and assigning tasks, and may have difficulties assigning tasks to appropriately-skilled individuals, or orchestrating resources and schedules.

### BRIEF DESCRIPTION OF THE DRAWINGS

Some embodiments are illustrated by way of example and not limitation in the figures of the accompanying drawings, in which like references indicate similar elements and in which:

FIG. 1 is a block diagram illustrating an example of a network suitable for a head mounted device system, according to some example embodiments;

FIG. 2 is a block diagram illustrating an example embodiment of a head mounted device;

FIG. 3 is a block diagram illustrating an example embodiment of a display controller;

FIG. 4 is a block diagram illustrating an example embodiment of a wearable device;

FIG. 5 is a block diagram illustrating an example embodiment of a server;

FIG. 6 illustrates the task management system providing task assignment functionality for, and task assist functionality to a wearer of an AR-capable wearable device such as an HMD, which may be similar to the HMD shown in FIG. 1;

FIG. 7 is a flow chart of a computer-implemented method for providing task management functionality to a user via AR;

FIG. 8 is a flow chart of a computer-implemented method for providing task management functionality to a user via AR;

FIG. 9 is a block diagram illustrating components of a machine, according to some example embodiments, able to read instructions from a machine-readable medium and perform any one or more of the methodologies discussed herein; and

FIG. 10 is a block diagram illustrating a mobile device, according to an example embodiment.

### DETAILED DESCRIPTION

Example methods and systems are directed to a task management system leveraging a head mounted device (HMD) of a wearer (e.g., a field service worker). Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one example embodiment, the HMD includes a wearable computing device (e.g., a helmet) with a display surface including a display lens capable of displaying augmented reality (AR) content, enabling the wearer to view both the display surface and their surroundings. The helmet may include a computing device such as a hardware processor with an AR application that allows the user wearing the helmet to experience information, such as in the form of a virtual object such as a three-dimensional (3D) virtual object overlaid on an image or a view of a physical object (e.g., a gauge) captured with a camera in the helmet. The helmet may include optical sensors. The physical object may include a visual reference (e.g., a recognized image, pattern, or object, or unknown objects) that the AR application can identify using predefined objects or machine vision. A visualization of the additional information (also referred to as AR content), such as the 3D virtual object overlaid or engaged with a view or an image of the physical object, is generated in the display lens of the helmet. The display lens may be transparent to allow the user see through the display lens. The display lens may be part of a visor or face shield of the helmet or may operate independently from the visor of the helmet. The 3D virtual object may be selected based on the recognized visual reference or captured image of the physical object. A rendering of the visualization of the 3D virtual object may be based on a position of the display relative to the visual reference. Other AR applications allow the user to experience visualization of the additional information overlaid on top of a view or an image of any object in the real physical world. The virtual object may include a 3D virtual object, a two-dimensional (2D) virtual object. For example, the 3D virtual object may include a 3D view of an engine part or an animation. The 2D virtual object may include a 2D view of a dialog box, menu, or written information such as statistics information for properties or physical characteristics of the corresponding physical object (e.g., temperature, mass, velocity, tension, stress). The AR content (e.g., image of the virtual object, virtual menu) may be rendered at the helmet or at a server in communication with the helmet. In one example embodiment, the user of the helmet may navigate the AR content using audio and visual inputs captured at the helmet, or other inputs from other devices, such as a wearable device. For example, the display lenses may extract or retract based on a voice command of the user, a gesture of the user, a position of a watch in communication with the helmet.

A system and method for task management using HMDs is described. In one example embodiment, wearers such as field service workers wear the HMD during their work day. The HMDs operate as a part of a task management system that assists the wearers with tasks using AR content provided by the HMDs and possibly remote systems in communication with the HMDs (e.g., networked servers, via wireless communication). The task management system provides various task assist functionality including task assignment, task preparation, task execution, and task verification.

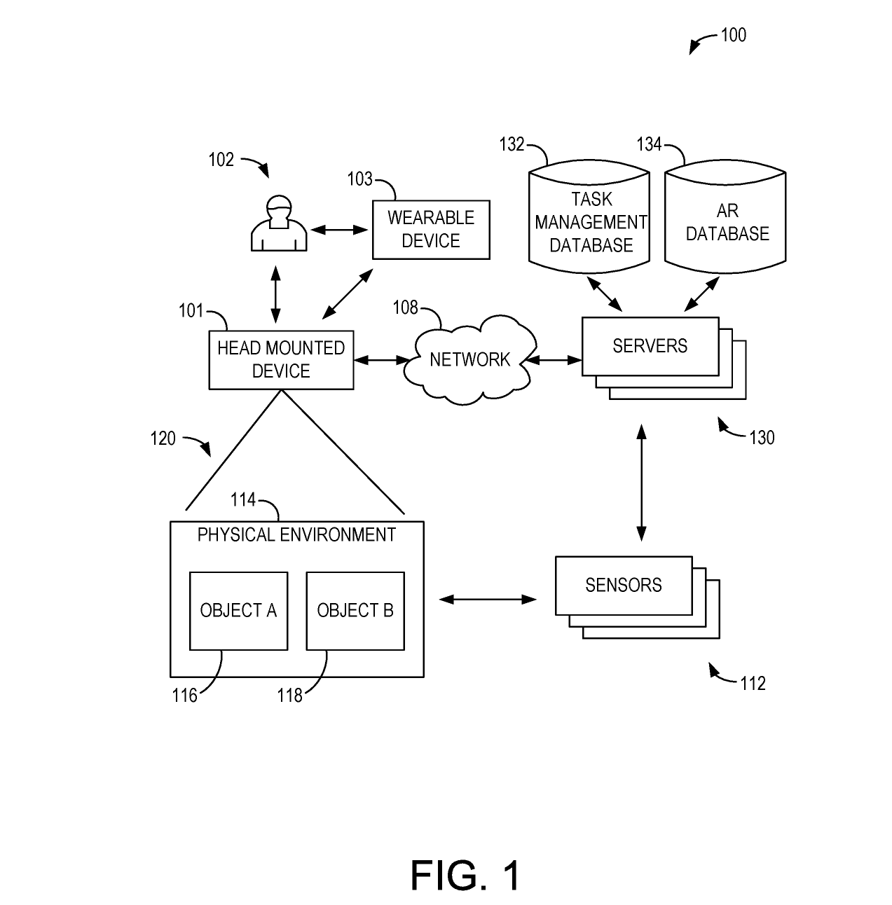

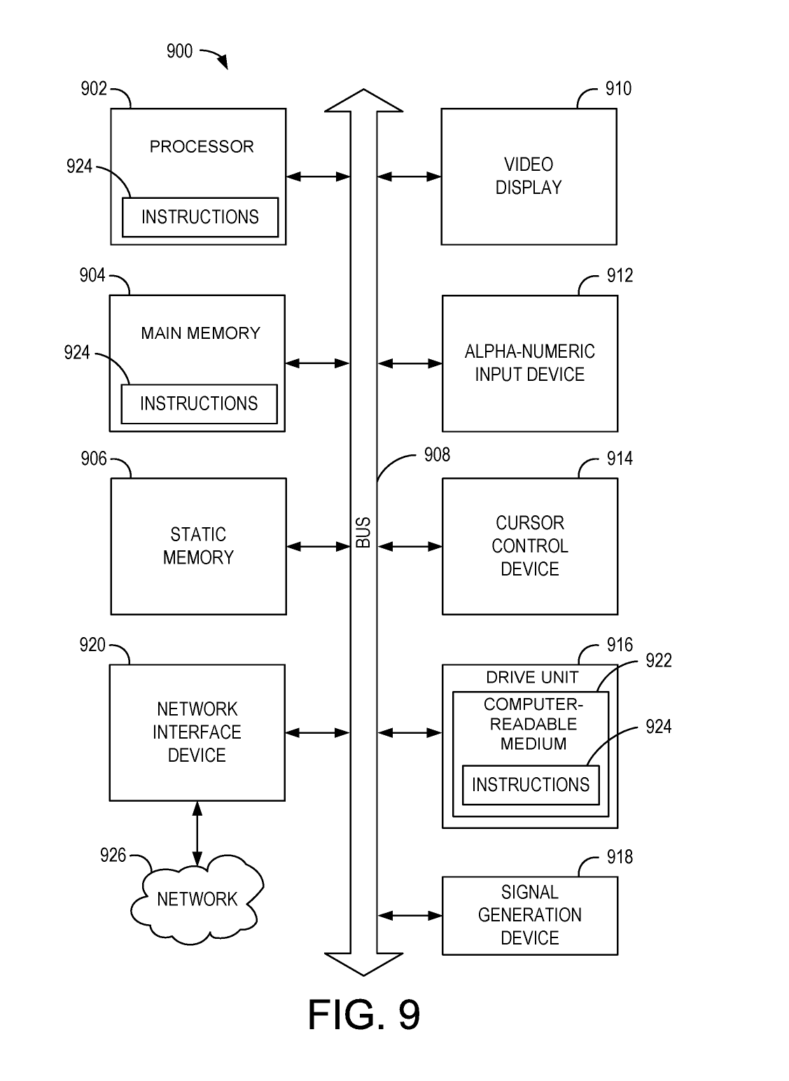

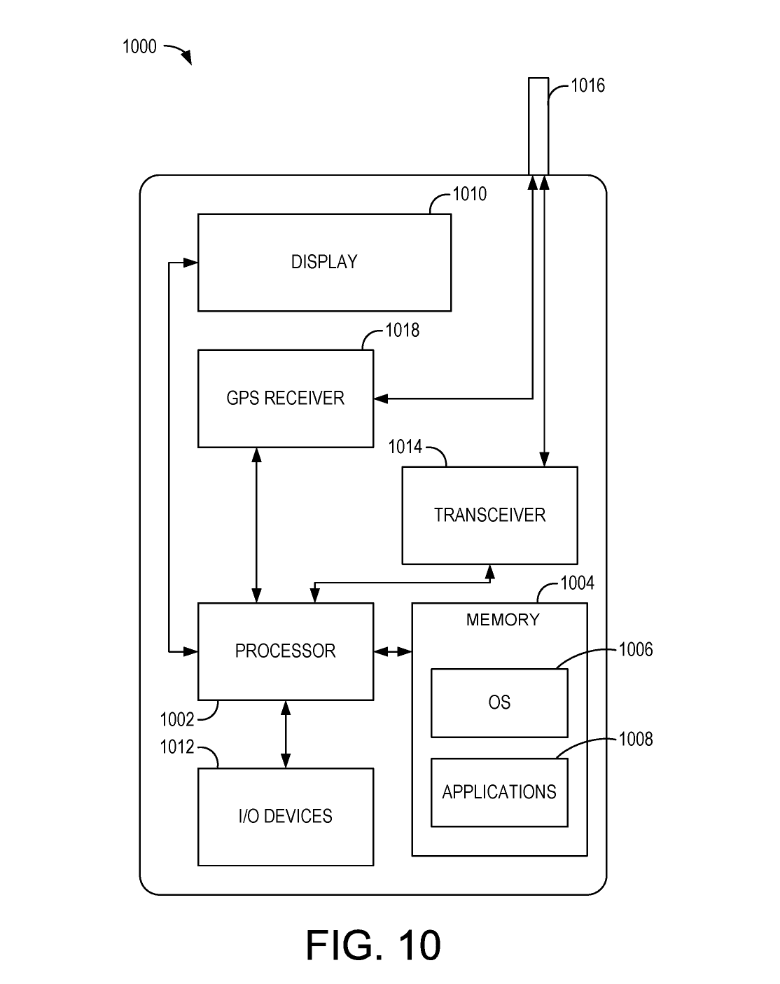

FIG. 1 is a network diagram illustrating a task management system 100 suitable for operating an augmented reality (AR) application of a wearable device such as a head mounted device (HMD) 101, according to some example embodiments. In the example embodiment, the task management system 100 includes the HMD 101 (or another wearable device with AR functionality), one or more servers 130, and a task management database 132, communicatively coupled to each other via a network 108. The HMD 101 and the servers 130 may each be implemented in a computer system, in whole or in part, as described below with respect to FIGS. 9 and 10. The task management system 100 provides task assist functionality to the wearer 102 through AR content presented via the HMD 101 or other wearable device. The task management system 100 may also provide task orchestration functionality to operations managers (not shown) or others assigned to coordinate the wearer(s) 102.

The servers 130 may be part of a network-based system. For example, the network-based system may be or include a cloud-based server system that provides AR content (e.g., augmented information including 3D models of virtual objects related to physical objects captured by the HMD 101) to the HMD 101.

In the example embodiment, the HMD 101 includes a helmet that a user (or “wearer”) 102 wears to view the AR content related to several physical objects (e.g., object A 116 and object B 118) in a real-world physical environment 114. In one example embodiment, the HMD 101 includes a computing device with a camera and a display (e.g., smart glasses, smart helmet, smart visor, smart face shield, smart contact lenses). The computing device may be removably mounted to the head of the user 102. In one example, the display may be a screen that displays what is captured with a camera of the HMD 101 (e.g., unaugmented, or augmented with AR content). In another example, the display of the HMD 101 may be transparent or semi-transparent surface such as in the visor or face shield of a helmet, or a display lens distinct from the visor or face shield of the helmet (e.g., onto which AR content may be displayed). While the example embodiments are described herein using an HMD 101, it should be understood that any other AR-capable computing devices or wearable computing devices that enable the systems and methods described herein may be used with the task management system 100 (e.g., tablets, watches, smartphones, windscreens, and so forth).

The user 102 may additionally wear other wearable computing devices, such as a wearable device 103 (e.g., a watch). In the example embodiment, the wearable device 103 communicates wirelessly with the HMD 101 to enable the user to control extension and retraction of the display. Components of the wearable device 103 are described in more detail with respect to FIG. 4.

The user 102 may be a user of an AR application (not separately depicted in FIG. 1) in the HMD 101 and at the servers 130. The user 102 may be a human user (e.g., a human being), a machine user (e.g., a computer configured by a software program to interact with the HMD 101), or any suitable combination thereof (e.g., a human assisted by a machine or a machine supervised by a human). The AR application may provide the user 102 with an AR experience triggered by identified objects in the physical environment 114. The physical environment 114 may include identifiable objects such as a 2D physical object (e.g., a picture), a 3D physical object (e.g., a factory machine), a location (e.g., at the bottom floor of a factory), or any references (e.g., perceived corners of walls or furniture) in the real-world physical environment 114. The AR application may include computer vision recognition to determine corners, objects, lines, and letters. The user 102 may point a camera of the HMD 101 to capture an image of the objects 116 and 118 in the physical environment 114.

In one example embodiment, the objects in the image are tracked and recognized locally in the HMD 101 using a local context recognition dataset or any other previously stored dataset of the AR application of the HMD 101 (e.g., locally on the HMD 101 or from an AR database 134). The local context recognition dataset module may include a library of virtual objects associated with real-world physical objects or references. In one example, the HMD 101 identifies feature points in an image of the devices 116, 118 to determine different planes (e.g., edges, corners, surface, dial, letters). The HMD 101 may also identify tracking data related to the devices 116, 118 (e.g., geolocation of the HMD 101 via GPS, orientation of the HMD 101 relative to the location of the devices 116, 118, distances to devices 116, 118). If the captured image is not recognized locally at the HMD 101, the HMD 101 can download additional information (e.g., 3D model or other augmented data) corresponding to the captured image, from the AR database 134 over the network 108.

In another embodiment, the objects 116, 118 in the image are tracked and recognized remotely at the server 130 using a remote context recognition dataset or any other previously stored dataset of an AR application in the server 130 and the AR database 134. The remote context recognition dataset module may include a library of virtual objects or augmented information associated with real-world physical objects or references.

Sensors 112 may be associated with, coupled to, or related to the devices 116 and 118 in the physical environment 114 (e.g., to measure a location, information, reading of the devices 116 and 118). Examples of measured reading may include and but are not limited to weight, pressure, temperature, velocity, direction, position, intrinsic and extrinsic properties, acceleration, and dimensions. For example, sensors 112 may be disposed throughout a factory floor to measure movement, pressure, orientation, and temperature. The servers 130 can compute readings from data generated by the sensors 112. The servers 130 can generate virtual indicators such as vectors or colors based on data from sensors 112. Virtual indicators are then overlaid on top of a live image of the devices 116 and 118 to show data related to the devices 116 and 118. For example, the virtual indicators may include arrows with shapes and colors that change based on real-time data. The visualization may be provided to the HMD 101 so that the HMD 101 can render the virtual indicators in a display of the HMD 101. In another embodiment, the virtual indicators are rendered at the servers 130 and streamed to the HMD 101. The HMD 101 displays the virtual indicators or visualization corresponding to a display of the physical environment 114 (e.g., data is visually perceived as displayed adjacent to the devices 116 and 118).

In some embodiments, the sensors 112 may include other sensors used to track the location, movement, and orientation of the HMD 101 externally without having to rely on sensors internal to the HMD 101. The sensors 112 may include optical sensors (e.g., depth-enabled 3D camera), wireless sensors (Bluetooth, Wi-Fi), GPS sensor, and audio sensor to determine the location of the user 102 having the HMD 101, distance of the user 102 to the tracking sensors 112 in the physical environment 114 (e.g., sensors placed in corners of a venue or a room), the orientation of the HMD 101 to track what the user 102 is looking at (e.g., direction at which the HMD 101 is pointed, HMD 101 pointed towards a player on a tennis court, HMD 101 pointed at a person in a room).

In another embodiment, data from the sensors 112 and internal sensors in the HMD 101 may be used for analytics data processing at the servers 130 (or another server) for analysis on usage and how the user 102 is interacting with the physical environment 114. Live data from other servers may also be used in the analytics data processing. For example, the analytics data may track at what locations (e.g., points or features) on the physical or virtual object the user 102 has looked, how long the user 102 has looked at each location on the physical or virtual object, how the user 102 moved with the HMD 101 when looking at the physical or virtual object, which features of the virtual object the user 102 interacted with (e.g., such as whether a user 102 tapped on a link in the virtual object), and any suitable combination thereof. The HMD 101 receives a visualization content dataset related to the analytics data. The HMD 101 then generates a virtual object with additional or visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIGS. 9 and 10. As used herein, a “database” is a data storage resource and may store data structured as a text file, a table, a spreadsheet, a relational database (e.g., an object-relational database), a triple store, a hierarchical data store, or any suitable combination or other format known in the art. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 130), databases (e.g., task management database 132), and devices (e.g., HMD 101, wearable device 103). Accordingly, the network 108 may be a wired network, a wireless network (e.g., Wi-Fi, mobile, or cellular network), or any suitable combination thereof. The network 108 may include one or more portions that constitute a private network, a public network (e.g., the Internet), or any suitable combination thereof.

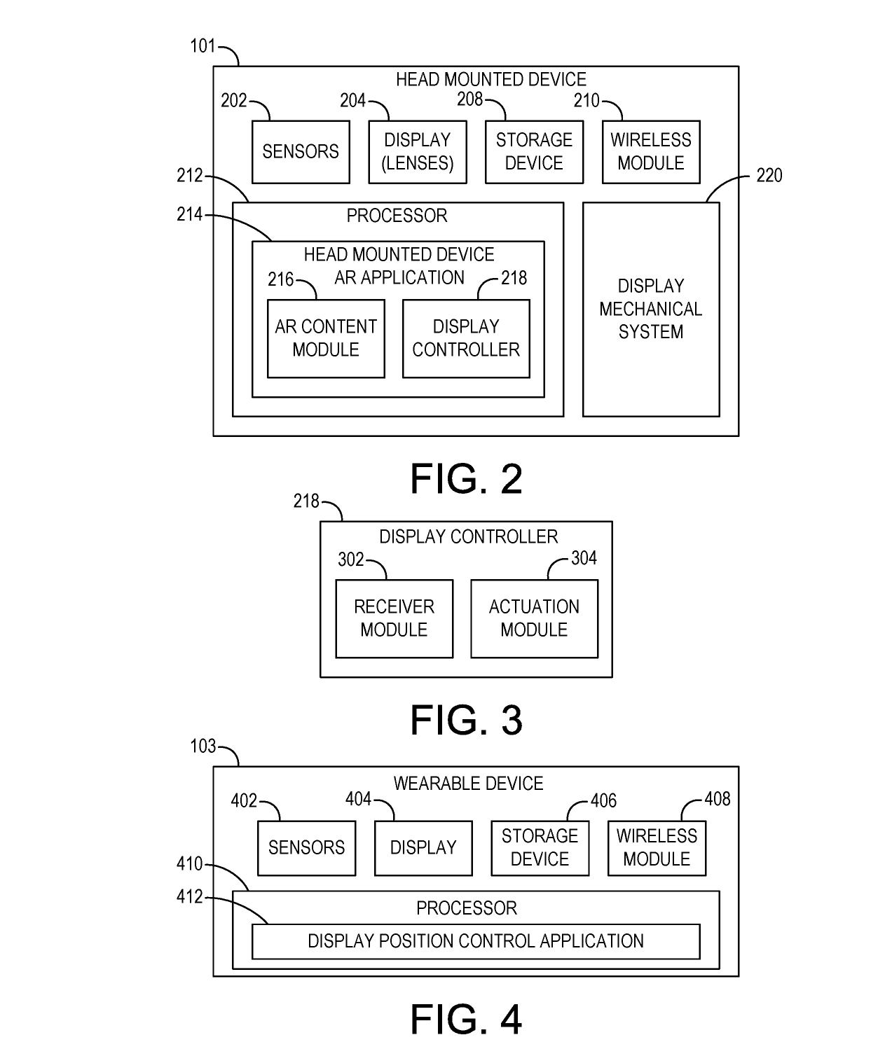

FIG. 2 is a block diagram illustrating modules (e.g., components) of the HMD 101, according to some example embodiments. The HMD 101 may be a helmet that includes sensors 202, a display 204, a storage device 208, a wireless module 210, a processor 212, and display mechanical system 220.

The sensors 202 may include, for example, a proximity or location sensor (e.g., Near Field Communication, GPS, Bluetooth, Wi-Fi), an optical sensor(s) (e.g., camera), an orientation sensor(s) (e.g., gyroscope, or an inertial motion sensor), an audio sensor (e.g., a microphone), or any suitable combination thereof. For example, the sensors 202 may include rear facing camera(s) and front facing camera(s) disposed in the HMD 101. It is noted that the sensors 202 described herein are for illustration purposes. Sensors 202 are thus not limited to the ones described. The sensors 202 may be used to generate internal tracking data of the HMD 101 to determine, for example, what the HMD 101 is capturing or looking at in the real physical world, or how the HMD is oriented. For example, a virtual menu may be activated when the sensors 202 indicate that the HMD 101 is oriented downward (e.g., when the user tilts his head to watch his wrist).

The display 204 includes a display surface or lens capable of displaying AR content (e.g., images, video) generated by the processor 212. In some embodiments, the display 204 may also include a touchscreen display configured to receive a user input via a contact on the touchscreen display. In some embodiments, the display 204 may be transparent or semi-transparent so that the user 102 can see through the display lens 204 (e.g., such as in a Head-Up Display).

The storage device 208 may store a database of identifiers of wearable devices capable of communicating with the HMD 101. In another embodiment, the database may also include visual references (e.g., images) and corresponding experiences (e.g., 3D virtual objects, interactive features of the 3D virtual objects). The database may include a primary content dataset, a contextual content dataset, and a visualization content dataset. The primary content dataset includes, for example, a first set of images and corresponding experiences (e.g., interaction with 3D virtual object models). For example, an image may be associated with one or more virtual object models. The primary content dataset may include a core set of images or the most popular images determined by the server 130. The core set of images may include a limited number of images identified by the server 130. For example, the core set of images may include the images depicting covers of the ten most viewed devices and their corresponding experiences (e.g., virtual objects that represent the ten most sensing devices in a factory floor). In another example, the server 130 may generate the first set of images based on the most popular or often scanned images received at the server 130. Thus, the primary content dataset does not depend on objects or images scanned by the HMD 101.

The contextual content dataset includes, for example, a second set of images and corresponding experiences (e.g., three-dimensional virtual object models) retrieved from the server 130. For example, images captured with the HMD 101 that are not recognized (e.g., by the server 130) in the primary content dataset are submitted to the server 130 for recognition (e.g., using the AR database 134). If the captured image is recognized by the server 130, a corresponding experience may be downloaded at the HMD 101 and stored in the contextual content dataset. Thus, the contextual content dataset relies on the context in which the HMD 101 has been used. As such, the contextual content dataset depends on objects or images scanned by the recognition module 214 of the HMD 101.

In one embodiment, the HMD 101 may communicate over the network 108 with the servers 130 and/or AR database 134 to retrieve a portion of a database of visual references, corresponding 3D virtual objects, and corresponding interactive features of the 3D virtual objects.

The wireless module 210 comprises a component to enable the HMD 101 to communicate wirelessly with other machines such as the servers 130, the task management database 132, the AR database 134, and the wearable device 103. The wireless module 210 may operate using Wi-Fi, Bluetooth, and other wireless communication means.

The processor 212 may include an HMD AR application 214 (e.g., for generating a display of information related to the objects 116, 118). In one example embodiment, the HMD AR application 214 includes an AR content module 216 and a display controller 218. The AR content module 216 generates a visualization of information related to the objects 116, 118 when the HMD 101 captures an image of the objects 116, 118 and recognizes the objects 116, 118 or when the HMD 101 is in proximity to the objects 116, 118. For example, the HMD AR application 210 may generate a display of a holographic or virtual menu visually perceived as a layer on the objects 116, 118. The display controller 218 is configured to control the display 204. For example, the display controller 218 controls an adjustable position of the display 204 in the HMD 101 and controls a power supplied to the display 204.

During operation, the task management system 100 generates and displays task-based AR content to the wearer 102 via the HMD 101 and, more specifically, via the HMD AR application 214 presenting task-based AR content onto the display 204. For example, the task management system 100 may generate and display task instructions or checklists on the display 204, or may highlight real-world components associated with the task, such as objects 116, 118, with AR content (e.g., a directional arrow pointing toward a nearby component, or a framing halo highlighting a component associated with the task).

FIG. 3 illustrates the display controller 218 which, in the example embodiment, includes a receiver module 302 and an actuation module 304. The receiver module 302 communicates with sensors 202 in the HMD 101 and the wearable device 103 to identify commands related to the display 204. For example, the receiver module 302 may identify an audio command (e.g., “lower glasses”) from the user 102 to lower a position of the display 204. In another example, the receiver module 302 may identify that AR content is associated with objects 116, 118, and lowers to the display 204 in the HMD 101. If no AR content is identified, the display 204 remains hidden in the HMD 101. In another example, the receiver module 302 determines whether AR content exists at the physical environment 114 based on the AR content module 216 and the server 130. In another example, the receiver module 302 identifies a signal from the wearable device 103 (e.g., command from the wearable device to lower the display, position of the wearable device relative to the HMD—lowered or raised) and adjusts the position of the display 204 based on the signal.

The actuation module 304 generates an actuation command to the display mechanical system 220 (e.g., motor, actuator) to raise the display 204 inside the HMD 101 or lower the display 204 outside the HMD 101 based on the determination made from the receiver module 302.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

During operation, the wearer 102 may engage or lower the display 204 while performing the tasks assigned by the task management system 100 (e.g., manually, as needed, or automatically by the HMD 101 as the active task demands). As such, the AR content provided by the task management system 100 may be engage situationally based on the task.

FIG. 4 is a block diagram illustrating modules (e.g., components) of the wearable device 103, according to some example embodiments. The wearable device 103 may include sensors 402, a display 404, a storage device 406, a wireless module 408, and a processor 410.

The sensors 402 may include, for example, a proximity or location sensor (e.g., Near Field Communication, GPS, Bluetooth, Wi-Fi), an optical sensor(s) (e.g., camera), an orientation sensor(s) (e.g., gyroscope, or an inertial motion sensor), an audio sensor (e.g., a microphone), or any suitable combination thereof.

The display 404 may also include a touchscreen display configured to receive a user input via a contact on the touchscreen display. In one example, the display 404 may include a screen configured to display images generated by the processor 410. The storage device 406 stores information about the HMD 101 for authentication. The wireless module 408 includes a communication device (e.g., Bluetooth device, Wi-Fi device) that enables the wearable device 103 to wirelessly communicate with the HMD 101.

The processor 410 may include a display position control application 412 for adjusting a position of the display 204 of the HMD 101. In one example embodiment, the display position control application 412 identifies operations on the wearable device 103 to the HMD 101. For example, the display position control application 412 may detect that the user 102 has pushed a particular button of the wearable device 103. The display position control application 412 communicates that information to the HMD 101 to identify a position of the display 204 based on the button that was pushed. The wearable device 103 may include one physical button for raising the display 204 of HMD 101 and another physical button for lowering the display 204 of HMD 101.

During operation, the wearer 102 engages the AR content provided by the task management system 100 by lowering the display 204 of the HMD 101 with the wearable device 103. In the some embodiments, the task management system 100 may be inactive (e.g., not transmitting or otherwise providing task-based AR content to the HMD 101) while the display 204 is raised and not in use by the wearer 102. When the wearer 102 engages the HMD 101 (e.g., lowering the display 204 with the wearable device 103), the task management system 100 may be engaged to actively provide the task-based AR content to the HMD 101. For example, the HMD 101 may transmit an activation command to the servers 130 upon lowering the display 204, thereby causing the servers 130 to begin or resume providing the task-based AR content.

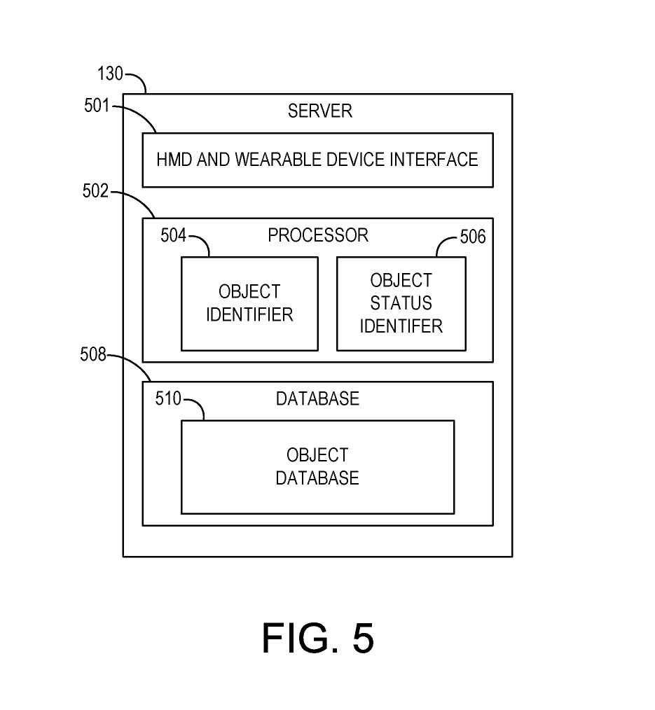

FIG. 5 is a block diagram illustrating modules (e.g., components) of the server 130. The server 130 includes an HMD and smartwatch interface 501, a processor 502, and a database 508. The HMD and smartwatch interface 501 may communicate with the HMD 101, the wearable device 103, and sensors 112 to receive real time data. The database 508 may be similar to the AR database 134 and/or the task management database 132.

The processor 502 may include an object identifier 504 and an object status identifier 506. The object identifier 504 may identify devices 116, 118 based on a picture or image frame received from the HMD 101. In another example, the HMD 101 already has identified devices 116, 118 and has provided the identification information to the object identifier 504. The object status identifier 506 determines the physical characteristics associated with the devices identified. For example, if the device is a gauge, the physical characteristics may include functions associated with the gauge, location of the gauge, reading of the gauge, other devices connected to the gauge, safety thresholds or parameters for the gauge. AR content may be generated based on the object identified and a status of the object.

The database 508 may store an object dataset 510. The object dataset 510 may include a primary content dataset and a contextual content dataset. The primary content dataset comprises a first set of images and corresponding virtual object models. The contextual content dataset may include a second set of images and corresponding virtual object models.

During operation, the server 130 may identify real-world objects associated with tasks assigned to the wearer 102 and may generate task-based AR content based on the tasks and the real-world objects. For example, for a task step that requires the wearer 102 to adjust a particular dial on a control panel, the server 130 may recognize the control panel (e.g., via computer vision from the HMD camera input), identify the particular dial on the control panel implicated by the task, and provide AR content highlighting that dial and/or instructions as to how to engage with the dial. As such, the task management system 101 provides the wearer 102 with task-based functionality using AR content, allowing the wearer 102 to maintain their hands free for performing the tasks.

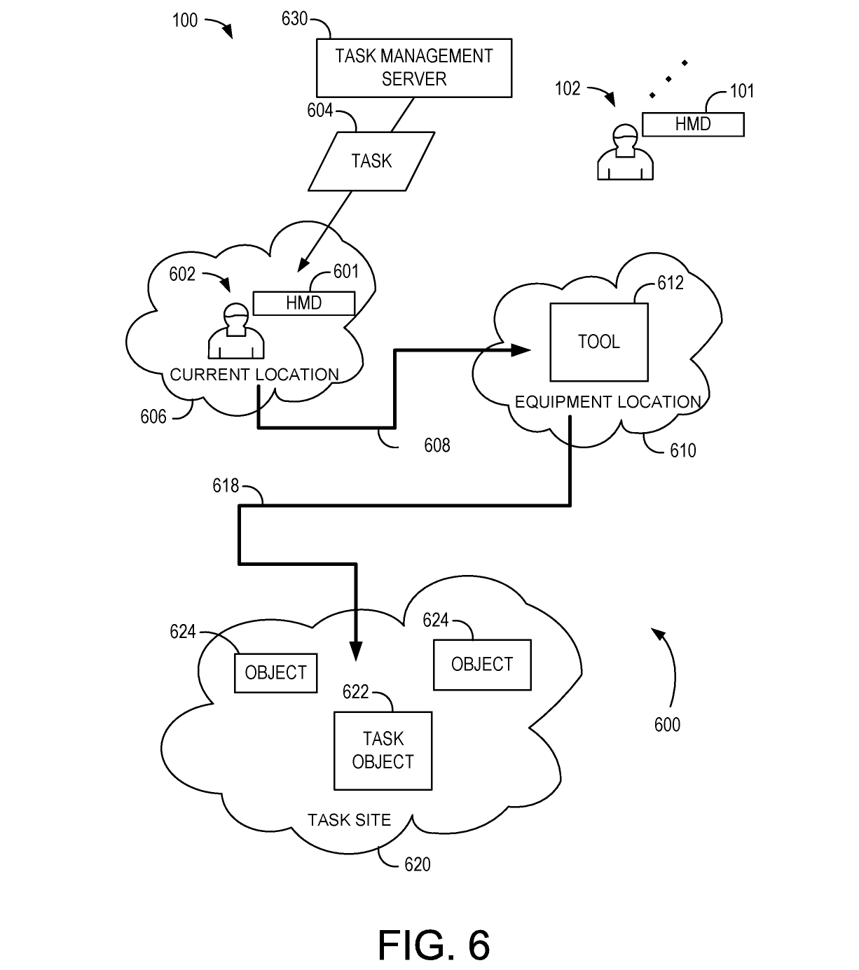

FIG. 6 illustrates the task management system 100 providing task assignment functionality for, and task assist functionality to, a wearer 602 of an AR-capable wearable device such as an HMD 601. In the example embodiment, the wearer 602 is a field service worker performing service operations in a work environment 600 (e.g., an oil refinery, a construction site, a power distribution grid). In some embodiments, the wearer 602 is one of a pool of workers (e.g., users 102) that may be managed by the task management system 100. The task management system 100 includes a task management server 630 in communication with each of the users 102, 602 through the HMDs 101, 601 (e.g., via wireless networking). The task management system 100 assigns tasks such as task 604 to the user 102, 602 during the course of their work day, and the users 102, 602 perform these tasks with the assistance of the task management system 100 and, more specifically, the HMD 101, 601. In some embodiments, the HMD 601 may be similar to the HMD 101, the user 602 may be similar to the user 102, and the task management server 630 may be similar to the servers 130.

The task management system 100 provides a variety of task assist functionalities, including task assignment functionalities (e.g., alerting, job availability, job allocation), task preparation functionalities (e.g., navigational aids, preparatory needs), task execution functionalities (e.g., instructions, sensor readings), and task verification functionalities (e.g., checklists, sensor readings). Further, the task 604 may include several task attributes, described in greater detail below, each of which may impact how the task management system 100 assists the wearer 602 in performing the task 604 through the use of the HMD 601.

In the example embodiment, the task management server 630 identifies a task 604 to be done and assigns the task 604 to the wearer 602. The task 604 includes operating on a task object 622 (e.g., an operations panel of a power generator) at a task site 620 known to the task management system 100 (e.g., a particular location within a power plant, where the operations panel is located). In some embodiments, the task object 622 may not be a physical object (e.g., the task objet 622 may be an inspection checklist presented via AR). Further, in some embodiments, the task 604 may require the use of a tool 612 or other piece of equipment. The tool 612 may be currently stored or otherwise located at an equipment location 610 known to the task management system 100.

In the example embodiment, the task management server 630 receives a current location 606 of the wearer 602 (e.g., via GPS location of the HMD 601, and association of the HMD 601 with the wearer 602). The task management server 630 automatically determines the equipment required to perform the task 604 (e.g., the task 604 identifies the tool 612 as required to perform the task 604), and locates the required equipment (e.g., the tool 612 is currently known to be available for use at the equipment location 610, such as via integrated GPS sensor or a tool management database). The task management server 630 plots a route 608 from the current location 606 of the wearer 602 to the equipment location 610 and, in some embodiments, to the tool 612. Further, through the HMD 601, the task management system 100 provides AR overlay display elements and/or audio instructions to the wearer 602, directing the wearer to the equipment location 610, thereby allowing the wearer 602 hands-free guidance to the equipment location 610.

After the wearer 602 has acquired the tool 612, the task management server 630 plots a route 618 from the location of the wearer 602 (e.g., from the equipment location 610) to the task site 620 (e.g., using a known GPS location of the site 620, or a pre-identified location within a digital site map (not shown)). Similarly, through the HMD 601, the task management system 100 provides AR overlay display elements and/or audio instructions to the wearer 620, directing the wearer to the task site 620 and, in some embodiments, to the task object 622 (e.g., by providing navigational aids via the HMD 101). For example, the task management system 100 may provide audio or AR visual driving directions while the wearer 602 drives to the task site 620, or may provide audio or AR visual walking directions or an AR pointer toward the task object 622 while the wearer 602 moves through the task site 620 to reach the task object 622. Once at the site 620, the task management system 100 provides various task execution and task verification functionalities to the wearer 602.

In some embodiments, the task management system 100 provides AR sub-task guidance to the wearer 602 for completing the task 604. Some tasks may include one or more sub-tasks required to complete the assigned task 604. For example, the task 604 may include a checklist of sub-tasks to be performed at the site 620. The wearer 602 may be presented, via the HUD 601, with task or sub-task operations to be performed, including visual instructions (e.g., text AR displayed on the HMD 601) and/or audio instructions (e.g., supplemental audio guidance). The HUD 601 enables the wearer 602 to be provided with the subtasks or checklist, hands-free, such that the wearer 602 is able to use both hands to perform the task 604 or associated subtasks, thereby keeping his hands and eyes focused on the task object 622 rather than, for example, having to look away to a paper checklist or other reference.

In some embodiments, the task management system 100 provides AR visual indicators or augmented work instructions to assist in performing the task 604 or associated sub-tasks. The task object 622 and other nearby objects 624 may be similar to objects 116, 118 (shown in FIG. 1). The HMD 601 may recognize and/or verify the task object 622 for the wearer 602 (e.g., confirming that the wearer 602 is operating on the proper device). The HMD 601 may also identify components of the task object 622 referenced by the task 622 or by a particular subtask. For example, if a subtask requires the wearer 602 to adjust a particular dial, or read a particular gauge, the HMD 601 may recognize the task object 622 (e.g., via camera input and orientation of the HMD 601, computer vision), locate the dial or gauge for this subtask, and provide AR display elements (e.g., blinking arrow, highlighted halo) to visually identify the dial or gauge for the wearer 602. In some embodiments, the HMD 601 may display data associated with the task 604 and/or the task object 622, such as data from sensors 112 associated with the task object 622, thereby allowing the wearer 602 hands-free access to device or alert data that may, for example, help the wearer 602 verify that the task 604 is going correctly, or notify the wearer 602 that something is wrong. Such functionality enables the wearer 602 to work hands-free, guided through subtasks by the task management system 100 (e.g., assisting less-experienced technicians), and further provides additional performance improvements by helping to ensure that the wearer 602 is operating on the particular equipment and components of that equipment indicated by the task 604 (e.g., not turning the wrong dial).

In some embodiments, tasks 604 may be associated with a particular task object (e.g., the task object 622), or to a particular location on, component of, or area of the task object 622 (e.g., a particular dial, panel, or screw). As such, when the wearer 602 has the task object 622 in their field of view, the task management system 100 may provide AR display elements to the wearer 602 based on the task object 622 (e.g., overlain on the panel, or adjacent to the dial, within the display 204). The task management system 100 may, for example, capture digital camera data of the task object 622 to determine where to provide the AR content relative to the task object 622. The task 604 may identify a location on a computer model of the task object 622. The digital camera data may be processed to determine the orientation and location of the task object 622, as well as the location identified by the task 604 on the computer model of the task object 622, thereby providing the location associated with the task 604 in the field of view of the wearer 602.

After the task 604 or associated subtasks are performed, the task management system 100 may provide additional task verification functionalities. For example, after some tasks, the task management system 100 may capture a video or digital photo of the completed work (e.g., the task object 622, or the particular gauge or dial), along with other task data such as location of the task object 622, task site 620, wearer 602, task 604 and subtasks, and tool 612 used. The task management system 100 may enable the wearer 602 to complete a checklist or sign-off sheet associated with the task 604 (e.g., additional subtasks after completion of some subtasks, to verify proper completion).

In the example embodiment, one task attribute included with the task 604 is one or more pieces of equipment (e.g., the tool 612) required to perform the task 604. The equipment may be, for example, a forklift, or a vibration gauge, or a replacement part. The task management system 100 automatically identifies the equipment necessary to perform the task 604 for the wearer 602, and in some embodiments, whether and where that equipment is available (status or availability, e.g., an in-use/unallocated status, or a mechanically fit for service status, or an in-inventory status). Some equipment may be trackable (e.g., via GPS or other device tracking method) and, as such, the task management system 100 may be able to determine a location for the asset. Further, the task management system 100 may manage availability of such equipment. For example, the tool 612 may be assigned to the wearer 602 for performing the task 604 and, as such, may be removed from a pool of assets until the task 604 is complete and the tool 612 is returned to the equipment location 610. As such, the wearer 602 need not waste time determining what equipment is required for the task, nor whether that equipment is available, nor where to find the equipment. In some embodiments, the HMD 601 may use computer vision to verify that the equipment selected (e.g., the tool 612) matches with the equipment assigned or necessary for the task 604.

In some embodiments, the task 604 may include skillset requirements for the task 604. For example, the task 604 may require a field service technician skilled in operating a forklift. The task management system 100 may maintain skillsets, certifications, and other skills data associated with users 102, 602. During task assignment, the task management server 630 may identify a user 102 who is skilled with the equipment and/or subtasks associated with the task 604 (such as wearer 602), and may select wearer 602 based on such skills data.

Further, in some embodiments, the task management server 630 may track availability of users 102, 602, and may assign tasks to users 102 based current status or availability (e.g., no current active task assigned), or based on an anticipated availability (e.g., wearer 602 is nearing completion of another task, and thus will soon be available to perform the task 604). In some embodiments, the task management server 630 may track location of the users 102, 602 and assign tasks to users 102 based on location of the user 102, 602. For example, the task management server 630 may determine users' 102 proximity to either the necessary equipment associated with a task, or on the task site of the task, based on geolocation data of their HMDs 101, 601 or geofencing data associated with locations 606, 610, 620, or based on proximity sensor data (e.g., within an operable range of the proximity sensor). In some embodiments, the task management server 630 may receive indication that the wearer 602 has become available (e.g., after an initial login, or after the wearer 602 has completed a previous task), and the task management server 630 may then search for a next task 604 for that wearer 602 (e.g., based on skillset, or location/proximity to sites 610, 620, or any combination thereof).

In some embodiments, the HMDs 101, 601 provide hands-free authentication of the users 102, 602. For example, the HMDs 101, 601 may include an iris scanner configured to perform iris recognition on the wearer 602 (e.g., at the time the wearer 602 first puts the HMD on). As such, the HMDs 101, 601 may associate a particular user 102 with a particular HMD 101 with added certainty as to who is wearing that particular HMD 101, and then begin tracking that user 102, and associate the skillset of that user 102 with the HMD 101. For example, there may be a pool of HMDs 101 used by a group of service technicians. When not in use, the HMDs 101 are inactive, and not associated with any particular user 102. When the wearer 602 begins his shift, they may select the HMD 601 from the pool if inactive HMDs 101 and mount the HMD 601 on their head. The HMD 601 may then iris-scan the wearer 602 to both verify access to the task management system 100 or other functionality, as well as associate the HMD 601 with the wearer 602.

In some embodiments, the task management system 100 may assign tasks 604 based on wearable device-based data. For example, during assignment of the task 604, the task management system 100 may factor in the current location 606 of the wearer 502 and the HMD 601, or biometric sensor data regarding the user (e.g., a level of tiredness or a length of time actively working), or capabilities of the HMD 601 (e.g., as between a standard model without a particular feature and a premium model that includes the feature), or a status of the HMD (e.g., remaining power level, or remaining storage). Further, in some embodiments, the task management system 100 may assist the wearer based on any of the same criteria. For example, the task management system 100 may provide a different set of instructions if the HMD 601 is the standard model (e.g., without the premium feature) than if the HMD 601 is the premium model (e.g., having the premium feature), or may limit the AR content activity provided by the HMD 601 when the power supply runs low, or may reassign tasks or subtasks when the level of tiredness or length of activity exceeds a pre-determined threshold. Similarly, if the wearer 602 is a more skilled or experienced user (e.g., as determined by a profile of the wearer 602), then the task management system 100 may present different AR content (e.g., abbreviated instructions) than to a less experienced wearer 602.

While the processing steps may be described above in as being performed by the task management server 630, the HMDs 101, 601, or the task management system 100 overall, it should be understood that those steps may be performed by other components of the task management system 100 that enable the systems and methods described herein.

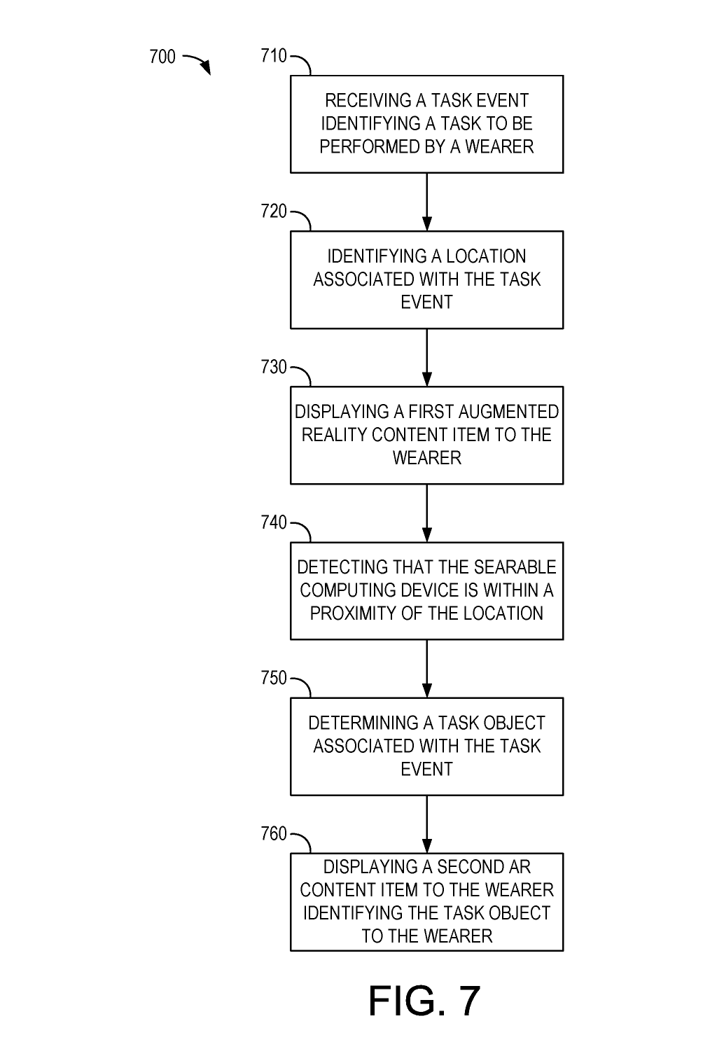

FIG. 7 is a flow chart of a computer-implemented method 700 for providing task management functionality to a user 102 via AR. The computer-implemented method 700, hereafter referred to as “the method 700,” is performed by a computing device comprising at least one hardware processor and a memory. In an example embodiment, the method 700 is performed by the head mounted device 101. In some embodiments, one or more operations of the method 700 may be performed by the server 130 (e.g., the task management server 630).

In the example embodiment, at operation 710, the method 700 includes receiving, at a wearable computing device, a task event identifying a task to be performed by a wearer. At operation 720, the method 700 includes identifying a location associated with the task event. At operation 730, the method 700 includes displaying a first augmented reality (AR) content item to the wearer using a display element of the wearable computing device, the first AR content item is a navigational aid associated with the location. At operation 740, the method 700 includes detecting, using input from a location sensor, that the wearable computing device is within a proximity of the location. At operation 750, the method 700 includes determining a task object associated with the task event. At operation 760, the method 700 includes displaying a second AR content item to the wearer using the display element, the second AR content item identifies the task object to the wearer in a field of view of the display element.

In some embodiments, the method 700 also includes identifying an object location of the task object based on input from a camera device. In some embodiments, the method 700 also includes determining that a first tool is associated with the task event, identifying an equipment location of the first tool, and displaying a third AR content item to the wearer using the display element, the third AR content item is a navigational aid associated with the equipment location. In some embodiments, the method 700 also includes determining that a first tool associated with the task event has been acquired by the wearer, and allocating the first tool to the task event. In some embodiments, the method 700 also includes identifying a third AR content item configured to assist the wearer in performing the task, and displaying the third AR content item to the wearer, using the display element, based on task object. In some embodiments, the method 700 also includes determining a skillset of the wearer, comparing the skillset of the wearer to a skillset associated with the task event, and identifying the third AR content item based on the comparison. In some embodiments, the method 700 also includes determining that the task event has been completed by the wearer, and capturing verification data associated with completion of the task event using a camera device of the wearable computing device.

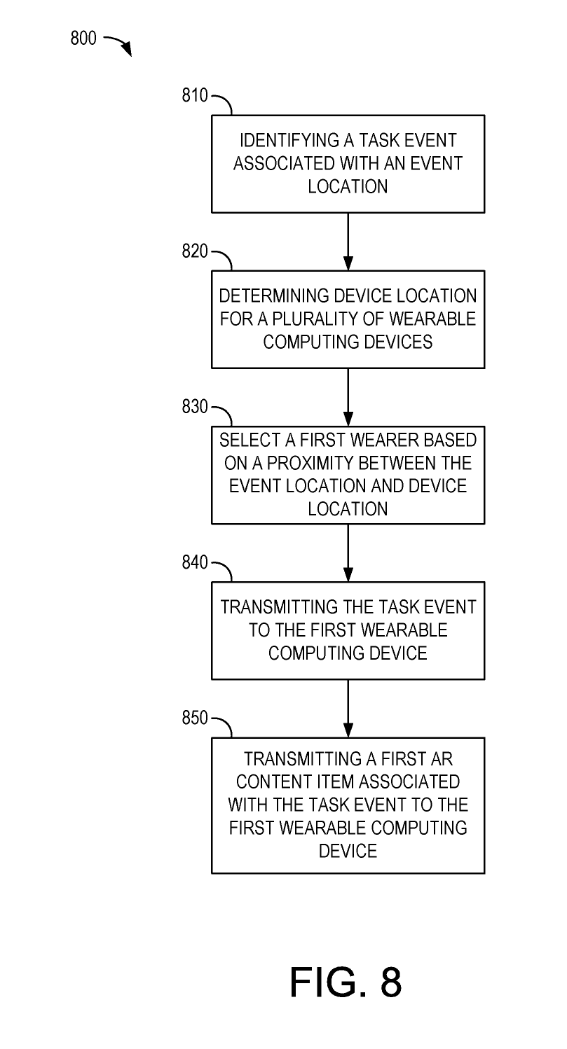

FIG. 8 is a flow chart of a computer-implemented method 800 for providing task management functionality to a user 102 via AR. The computer-implemented method 800, hereafter referred to as “the method 800,” is performed by a computing device comprising at least one hardware processor and a memory. In an example embodiment, the method 800 is performed by the server 130 (e.g., the task management server 630). In some embodiments, one or more operations of the method 900 may be performed by the head mounted device 101.

In the example embodiment, at operation 810, the method 800 includes identifying a task event, the task event is associated with an event location. At operation 820, the method 800 includes determining device location for each wearable computing device of the plurality of wearable computing devices. At operation 830, the method 800 includes selecting a first wearer from the plurality of wearers based on a proximity between the event location and device location, the first wearer is associated with a first wearable computing device of the plurality of wearable computing devices. At operation 840, the method 800 includes transmitting the task event to the first wearable computing device. At operation 850, the method 800 includes transmitting a first AR content item associated with the task event to the first wearable computing device for presentation to the first wearer.

In some embodiments, the method 800 also includes identifying an event skillset associated with the task event, and comparing the event skillset and skillsets of the plurality of wearers, wherein selecting the first wearer is further based on the comparison. In some embodiments, the method 800 also includes determining an availability status of the first wearer, wherein selecting the first wearer is further based on the availability status of the first wearer. In some embodiments, the task event is further associated with a first task object, and the method 800 also includes receiving video input from the first wearable computing device, the video input is captured at the event site, identifying the first task object from the video input, determining a location of the first task object relative to the first wearable computing device, and transmitting a first AR content item to the first wearable computing device for display to the first wearer, the first AR content item is displayed proximate the first task object in a field of view of the first wearable computing device.

In some embodiments, the method 800 also includes identifying task event data associated with the task event, generating a first AR content item including the task event data, and transmitting the first AR content item to the first wearable computing device for display to the first wearer. In some embodiments, the method 800 also includes determining that a first tool is associated with the task event, identifying an equipment location of the first tool, and transmitting a second AR content item to the wearer using the display element, the second AR content item is a navigational aid associated with the equipment location. In some embodiments, the method 800 also includes determining that a first tool associated with the task event has been acquired by the wearer, and allocating the first tool to the task event.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 9 is a block diagram of a machine in the example form of a computer system 900 within which instructions 924 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation (or cursor control) device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media. The instructions 924 may also reside, completely or at least partially, within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, POTS networks, and wireless data networks (e.g., Wi-Fi and WiMax networks). The term “transmission medium” shall be taken to include any intangible medium capable of storing, encoding, or carrying instructions for execution by the machine, and includes digital or analog communications signals or other intangible media to facilitate communication of such software.

### Example Mobile Device

FIG. 10 is a block diagram illustrating a mobile device 1000, according to an example embodiment. The mobile device 1000 may include a processor 1002. The processor 1002 may be any of a variety of different types of commercially available processors 1002 suitable for mobile devices 1000 (for example, an XScale architecture microprocessor, a microprocessor without interlocked pipeline stages (MIPS) architecture processor, or another type of processor 1002). A memory 1004, such as a random access memory (RAM), a flash memory, or other type of memory, is typically accessible to the processor 1002. The memory 1004 may be adapted to store an operating system (OS) 1006, as well as application programs 1008, such as a mobile location enabled application that may provide LBSs to a user. The processor 1002 may be coupled, either directly or via appropriate intermediary hardware, to a display 1010 and to one or more input/output (I/O) devices 1012, such as a keypad, a touch panel sensor, a microphone, and the like. Similarly, in some embodiments, the processor 1002 may be coupled to a transceiver 1014 that interfaces with an antenna 1016. The transceiver 1014 may be configured to both transmit and receive cellular network signals, wireless data signals, or other types of signals via the antenna 1016, depending on the nature of the mobile device 1000. Further, in some configurations, a GPS receiver 1018 may also make use of the antenna 1016 to receive GPS signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A wearable computing device comprising:
at least one processor;
a display element configured to display augmented reality (AR) content to a wearer of the wearable computing device;
a location sensor providing location information associated with the wearable computing device; and
a task management engine, executed by the at least one processor, configured to:
receive a task event identifying a task to be performed by the wearer;
identify a location associated with the task event;
display a first AR content item to the wearer using the display element, the first AR content item is a navigational aid associated with the location;
detect, using input from the location sensor, that the wearable computing device is within a proximity of the location;
determine a task object associated with the task event; and
display a second AR content item to the wearer using the display element, the second AR content item identifies the task object to the wearer in a field of view of the display element.

2. The wearable computing device of claim 1 further comprising:
a camera device configured to capture digital video,
wherein the task management engine is further configured to identify an object location of the task object based on input from the camera device.

3. The wearable computing device of claim 1, wherein the task management engine is further configured to:
determine that a first tool is associated with the task event;
identify an equipment location of the first tool; and
display a third AR content item to the wearer using the display element, the third AR content item is a navigational aid associated with the equipment location.

4. The wearable computing device of claim 1, wherein the task management engine is further configured to:
determine that a first tool associated with the task event has been acquired by the wearer; and
allocate the first tool to the task event.

5. The wearable computing device of claim 1, wherein the task management engine is further configured to:
identify a third AR content item configured to assist the wearer in performing the task; and
display the third AR content item to the wearer, using the display element, based on the task object.

6. The wearable computing device of claim 5, wherein the task management engine is further configured to:
determine a skillset of the wearer;
compare the skillset of the wearer to a skillset associated with the task event; and
identify the third AR content item based on the comparison.

7. The wearable computing device of claim 1 further comprising:
a camera device configured to capture digital video,
wherein the task management engine is further configured to:
determine that the task event has been completed by the wearer; and
capture verification data associated with completion of the task event using the camera device.

8. A task management system comprising:
at least one processor;
a task management server, communicatively coupled to a plurality of wearable computing devices, each wearable computing device of the plurality of wearable computing devices is associated with a wearer of a plurality of wearers, the task management server is configured to:
identify a task event, the task event is associated with an event location;
determine device location for each wearable computing device of the plurality of wearable computing devices;
select a first wearer from the plurality of wearers based on a proximity between the event location and device location, the first wearer is associated with a first wearable computing device of the plurality of wearable computing devices;
transmit the task event to the first wearable computing device; and
transmit a first AR content item associated with the task event to the first wearable computing device for presentation to the first wearer.

9. The task management system of claim 8, wherein the task management server is further configured to:
identify an event skillset associated with the task event;
compare the event skillset and skillsets of the plurality of wearers,
wherein selecting the first wearer is further based on the comparison.

10. The task management system of claim 8, wherein the task management server is further configured to:
determine an availability status of the first wearer,
wherein selecting the first wearer is further based on the availability status of the first wearer.

11. The task management system of claim 8, wherein the task event is further associated with a first task object, wherein the task management system is further configured to:
receive video input from the first wearable computing device, the video input is captured at the event site;
identify the first task object from the video input;
determine a location of the first task object relative to the first wearable computing device; and
transmit a first AR content item to the first wearable computing device for display to the first wearer, the first AR content item is displayed based on the first task object.

12. The task management system of claim 8, wherein the task management server is further configured to:
identify task event data associated with the task event;
generate a first AR content item including the task event data; and
transmit the first AR content item to the first wearable computing device for display to the first wearer.

13. The task management system of claim 8, wherein the task management server is further configured to:
determine that a first tool is associated with the task event;
identify an equipment location of the first tool; and
transmit a second AR content item to the wearer using the display element, the second AR content item is a navigational aid associated with the equipment location.

14. The task management system of claim 8, wherein the task management server is further configured to:
determine that a first tool associated with the task event has been acquired by the wearer; and
allocate the first tool to the task event.

15. A computer-implemented method comprising:
receiving, at a wearable computing device, a task event identifying a task to be performed by a wearer;
identifying a location associated with the task event;
displaying a first augmented reality (AR) content item to the wearer using a display element of the wearable computing device, the first AR content item is a navigational aid associated with the location;
detecting, using input from a location sensor, that the wearable computing device is within a proximity of the location;
determining a task object associated with the task event; and
displaying a second AR content item to the wearer using the display element, the second AR content item identifies the task object to the wearer in a field of view of the display element.

16. The computer-implemented method of claim 15 further comprising identifying an object location of the task object based on input from a camera device.

17. The computer-implemented method of claim 15 further comprising:
determining that a first tool is associated with the task event;
identifying an equipment location of the first tool; and
displaying a third AR content item to the wearer using the display element, the third AR content item is a navigational aid associated with the equipment location.

18. The computer-implemented method of claim 17 further comprising:
determining that a first tool associated with the task event has been acquired by the wearer; and
allocating the first tool to the task event.

19. The computer-implemented method of claim 17 further comprising:
identifying a third AR content item configured to assist the wearer in performing the task; and
displaying the third AR content item to the wearer, using the display element, based on the task object.

20. The computer-implemented method of claim 17 further comprising:
determining a skillset of the wearer;
comparing the skillset of the wearer to a skillset associated with the task event; and
identifying the third AR content item based on the comparison.

21. The computer-implemented method of claim 17 further comprising:
determining that the task event has been completed by the wearer; and
capturing verification data associated with completion of the task event using a camera device of the wearable computing device.

22. A non-transitory machine-readable medium storing processor-executable instructions which, when executed by a processor, cause the processor to:
receive, at a wearable computing device, a task event identifying a task to be performed by a wearer;
identify a location associated with the task event;
display a first augmented reality (AR) content item to the wearer using a display element of the wearable computing device, the first AR content item is a navigational aid associated with the location;
detect, using input from a location sensor, that the wearable computing device is within a proximity of the location;
determine a task object associated with the task event; and
display a second AR content item to the wearer using the display element, the second AR content item identifies the task object to the wearer in a field of view of the display element.

23. The machine-readable medium of claim 22, wherein the processor-executable instructions further cause the processor to identifying an object location of the task object based on input from a camera device.

24. The machine-readable medium of claim 22, wherein the processor-executable instructions further cause the processor to:
determine that a first tool is associated with the task event;
identify an equipment location of the first tool; and
display a third AR content item to the wearer using the display element, the third AR content item is a navigational aid associated with the equipment location.

25. The machine-readable medium of claim 24, wherein the processor-executable instructions further cause the processor to:
determine that a first tool associated with the task event has been acquired by the wearer; and
allocate the first tool to the task event.

26. The machine-readable medium of claim 22, wherein the processor-executable instructions further cause the processor to:
identify a third AR content item configured to assist the wearer in performing the task; and
display the third AR content item to the wearer, using the display element, based on the task object.

27. The machine-readable medium of claim 22, wherein the processor-executable instructions further cause the processor to:
determine a skillset of the wearer;
compare the skillset of the wearer to a skillset associated with the task event; and
identify the third AR content item based on the comparison.

28. The machine-readable medium of claim 22, wherein the processor-executable instructions further cause the processor to:
determine that the task event has been completed by the wearer; and
capture verification data associated with completion of the task event using a camera device of the wearable computing device.
